(19) United States
(12) Patent Application Publication
(10) Pub. No.: US 2011/0158078 A1
(43) Pub. Date: Jun. 30, 2011

(54) OPTICAL PICKUP DEVICE AND FOCUS JUMP METHOD

(75) Inventor: Makoto Sato, Tokorozawa (JP)

(73) Assignee: PIONEER CORPORATION, Meguro-ku, Tokyo (JP)

(21) Appl. No.: 13/003,550

(22) PCT Filed: Jul. 11, 2008
(86) PCT No.: PCT/JP2008/062582

§ 371 Date: Mar. 8, 2011

(51) Int. Cl. G11B 27/36; G11B 7/135

(52) U.S. Cl. 369/112.23; 369/53.28; G9B/27.052; G9B/7.112

(57) ABSTRACT

In an optical pickup device and a method of a focus jump, in order to make optimum correction of spherical aberration responsive to the position of a recording layer at one end nearer a target recording layer than a current in-focus recording layer, the recording layer at the one end being one of recording layers at opposite ends of a plurality of recording layers, spherical aberration correcting means is controlled, and then a focus actuator is controlled, thereby causing a focus to jump to the recording layer at the one end. Next, in order to make optimum correction of spherical aberration responsive to the position of a different recording layer shifted by at least one recording layer from the recording layer at the one end toward the target recording layer, the spherical aberration correcting means is controlled, then the focus actuator is controlled, the focus is caused to jump to the different recording layer, and such a focus jump is repeated until the focus reaches the target recording layer.

### TECHNICAL FIELD

The invention relates to an optical pickup device used for an optical recording medium with a large number of recording layers, and a method of a focus jump between the recording layers.

### BACKGROUND ART

An optical system with an objective lens and other optical elements provided in an optical pickup device that emits a laser beam for recording or playback of an optical disk with a single recording layer is generally designed to make the spherical aberration of a laser beam zero if a depth from a surface of incidence of the optical disk to a recording layer is a predetermined specific value. Accordingly, if the depth to the recording layer differs from the specific value, a spherical aberration in response to the depth error is generated. In an optical disk with a large number of stacked recording layers, a total thickness of intermediate layers between protective layers or between recording layers differs among the recording layers. Thus, each recording layer generally has its own value of spherical aberration. Accordingly, spherical aberration correcting means such as an expander lens and a liquid crystal element should be provided in an optical pickup device for reading and writing information from and to an optical disk. Correcting a spherical aberration to its best condition with the spherical aberration correcting means makes the amplitude of a servo signal such as a focus error signal maximum while making the amplitude of a readout signal maximum, thereby achieving the highest quality of a playback signal.

FIG. 1(a) shows how playback is performed with the focus of a laser beam as read light placed on a fifth recording layer of an optical disk with 16 recording layers. FIG. 1(b) shows the amplitude of a focus error signal corresponding to the position of each recording layer that is defined by changing the focus position of the laser beam. This optical disk has a first recording layer that is nearest a surface of incidence of a laser beam, and a sixteenth recording layer that is a bottom recording layer. Spherical aberration correction is optimized for the fifth recording layer. Accordingly, as shown in FIG. 1(b), the amplitude of the focus error signal becomes maximum at a position corresponding to the fifth recording layer, and decreases significantly with a greater distance from a corresponding recording layer to the fifth recording layer.

FIG. 2 shows the amplitude of the focus error signal of FIG. 1(b) in an enlarged manner. The focus error signal becomes 0V when focusing of a laser beam is made on a recording layer. Here, focusing means that a focus is placed on a recording layer, and corresponds to a state where zero-crossing points A, B, C, D, and E of the focus error signal are focused on third, fourth, fifth, sixth, and seventh recording layers, respectively. The focus error signal can have a sufficient amplitude within a range of the third to seventh recording layers with the fifth recording layer at the center. Thus, in order for a focus placed on the fifth recording layer to jump to a different recording layer of the third to seventh recording layers, the focus error signal can be used for focusing.

However, in order for a focus to jump from the fifth recording layer to a fairly distant target recording layer such as a thirteenth recording layer as indicated by an arrow of FIG. 3(a), no amplitude of the focus error signal is generated at the recording layer as the destination of the jump as shown by a portion indicated by reference X in FIG. 3(b). Thus, the focus error signal cannot be used without being processed.

As a countermeasure technique, a focus jumps from a current in-focus recording layer to a next recording layer to get nearer a target recording layer, and appropriate spherical aberration correction is performed. This process is repeated until a focus jumps to the target recording layer. Further, in a publicly known method of a focus jump, appropriate spherical aberration correction is performed in an intermediate position between a current in-focus recording layer and a target recording layer, or in the target recording layer, and then a focus jumps to the target recording layer (see patent literatures 1 and 2).

[Patent Literature 1] Japanese Patent Kokai No. 2003-16660

[Patent Literature 2] Japanese Patent Kokai No. 2002-157750

### DISCLOSURE OF INVENTION

### Problem to be Solved by Invention

However, in the former conventional technique, a focus jump to a next recording layer is repeated. Thus, it takes much time to complete a focus jump if a target recording layer is far from a current in-focus recording layer. In the latter conventional technique, a focus error signal has no amplitude in a certain section during a focus jump as shown in FIG. 4(b) if a current in-focus recording layer and a target recording layer are far from each other. This makes it impossible to count the number of recording layers to which a focus jumped by using zero-crossing of the focus error signal. Further, a focus error signal is generated for a plurality of recording layers including the target recording layer as shown in FIG. 4(a) when the focus of a laser beam reaches a position near the target recording layer. Accordingly, the laser beam may be directed to a recording layer except the target recording layer in response to the generated focus error signal, failing to achieve a reliable focus jump to the target recording layer.

The aforementioned problem is an example of a problem to be solved by the invention. The invention is intended to provide an optical pickup device and a method of a jump capable of achieving a reliable focus jump to a target recording layer in a short time in an optical recording medium with a plurality of stacked recording layers.

### Means for Solving Problem

An optical pickup device of the invention according to claim 1 is an optical pickup device for optically reading or writing information from and to an optical recording medium with a plurality of stacked recording layers. The optical pickup device includes: a light source for emitting a laser beam for reading or writing; an optical system for directing the laser beam emitted from the light source through an objective lens to apply the laser beam to the optical recording medium; a focus actuator for causing the objective lens to move in a direction of an optical axis of the objective lens such that a focus of the laser beam is placed within at least a range of the plurality of recording layers; spherical aberration correcting means in the optical system provided on an optical path between the light source and the objective lens, the spherical aberration correcting means making optimum correction of spherical aberration generated in the optical system including the optical recording medium; and control means for controlling each of the focus actuator and the spherical aberration correcting means. The control means includes: first stage means, in response to generation of an instruction for a focus jump from a current in-focus recording layer to a target recording layer of the plurality of recording layers, in order to make optimum correction of spherical aberration responsive to a position of a recording layer at one end nearer the target recording layer than the current in-focus recording layer, the recording layer at the one end being one of recording layers at opposite ends of the plurality of recording layers, the first stage means controlling the spherical aberration correcting means, and then controlling the focus actuator, thereby causing the focus to jump to the recording layer at the one end; and second stage means, after the focus jumps to the recording layer at the one end by the first stage means, in order to make optimum correction of spherical aberration responsive to a position of a different recording layer shifted by at least one recording layer from the recording layer at the one end toward the target recording layer, the second stage means controlling the spherical aberration correcting means, then controlling the focus actuator, causing the focus to jump to the different recording layer, and repeating such a focus jump until the focus reaches the target recording layer.

A method of a focus jump of the invention according to claim 7 is performed in an optical pickup device including: an optical system for directing a laser beam emitted from a light source through an objective lens to apply the laser beam to an optical recording medium with a plurality of stacked recording layers; a focus actuator for causing the objective lens to move in a direction of an optical axis of the objective lens such that the focus of the laser beam is placed within at least a range of the plurality of recording layers; and spherical aberration correcting means in the optical system provided on an optical path between the light source and the objective lens, the spherical aberration correcting means making optimum correction of spherical aberration generated in the optical system including the optical recording medium. The method of a focus jump causes a focus to jump from a current in-focus recording layer to a target recording layer of the plurality of recording layers. The method of a focus jump includes: a first stage, in order to make optimum correction of spherical aberration responsive to a position of a recording layer at one end nearer the target recording layer than the current in-focus recording layer, the recording layer at the one end being one of recording layers at opposite ends of the plurality of recording layers, the first stage controlling the spherical aberration correcting means, and then controlling the focus actuator, thereby causing the focus to jump to the recording layer at the one end; and a second stage performed after the first stage, in order to make optimum correction of spherical aberration responsive to a position of a different recording layer shifted by at least one recording layer from the recording layer at the one end toward the target recording layer, the second stage controlling the spherical aberration correcting means, then controlling the focus actuator, causing the focus to jump to the different recording layer, and repeating such a focus jump until the focus reaches the target recording layer.

### BEST MODE(S) FOR CARRYING OUT INVENTION

In the optical pickup device of the invention according to claim 1 and the method of a focus jump of the invention according to claim 7, a focus does not jump from the current in-focus recording layer directly to the target recording layer. After optimum correction of spherical aberration responsive to the position of a recording layer at one end nearer the target recording layer than the current in-focus recording layer is made, the recording layer at the one end being one of recording layers at opposite ends of the plurality of recording layers, the focus once jumps to the recording layer at the one end. This provides reliability, compared to a focus jump to an intermediate recording layer to which a focus is hard to direct. After the focus jumps to the recording layer at the one end, optimum correction of spherical aberration and a focus jump are made at least for each recording layer in a direction from the recording layer at the one end toward the target recording layer. These are repeated until the focus reaches the target recording layer. Accordingly, in the optical recording medium with the plurality of stacked recording layers, a focus can reliably jump to the target recording layer in a short time. A time required for completion of a focus jump is shortened especially if the number of recording layers from the target recording layer to the recording layer at the one end is small, compared to that of recording layers from the current in-focus recording layer to the target recording layer.

### EXAMPLE(S)

Example of the invention is described in detail with reference to the drawings.

FIG. 5 shows the structure of an optical pickup device of the invention. The optical pickup device includes an optical system and a signal processing system, and optically writes and/or reads information to and from an optical disk 10 with a large number of stacked recording layers. In this Example, the optical disk 10 includes n (16, for example) recording layers.

The optical system includes a light source 1, a collimator lens 2, a beam splitter 3, an expander lens 4, an objective lens 5, a condenser lens 6, and a light receiving element 7. The signal processing system includes a signal processing circuit 11, a controller 12, an objective lens driving circuit 13, and a spherical aberration correcting element driving circuit 14.

The light source 1 is a semiconductor laser element for emitting laser beams. The collimator lens 2 converts laser beams emitted from the light source 1 to parallel beams, and supplies the parallel beams to the beam splitter 3. The beam splitter 3 transfers the parallel laser beams supplied from the collimator lens 2 directly to the expander lens 4. The expander lens 4 is a spherical aberration correcting element, and has first and second correction lenses 4a and 4b. The second correction lenses 4b is driven by an actuator 4c, and is movable in the direction of an optical axis. The position of the second correction lens 4b is changed to change a distance between the first and second correction lenses 4a and 4b, thereby allowing spherical aberration correction of each recording layer of the optical disk 10. The laser beams after passing through the expander lens 4 are supplied to the objective lens 5. The objective lens 5 causes the parallel laser beams to converge. The objective lens 5 has an actuator 5a with a focusing part for causing the objective lens 5 to move in the direction of the optical axis, and a tracking part for causing the objective lens 5 to move in the direction of a disk radius that is perpendicular to the optical axis. The focusing part can place the focus of a laser beam onto any one of the n recording layers of the optical disk 10. The tracking part can place the optical spot of the laser beam on the track of this recording layer.

The laser beam reflected off any one of the recording layers of the optical disk 10 returns as parallel laser beams to the beam splitter 3 through the objective lens 5 and the expander lens 4. Next, the beam splitter 3 causes reflection of the received laser beams at an angle of about 90 degrees with respect to the incidence, and supplies the reflected laser beams to the condenser lens 6. The condenser lens 6 condenses the reflected laser beams on the light receiving surface of the light receiving element 7 to form a spot on the light receiving surface. The light receiving surface of the light receiving element 7 is divided into four quadrants, for example. The light receiving element 7 generates a voltage signal for each quadrant the level of which is responsive to the intensity of received light.

The signal processing circuit 11 generates an RF signal that is a read signal of recorded information in response to an output voltage signal of the light receiving element 7. The signal processing circuit 11 also generates servo signals such as a focus error signal and a tracking error signal. A focus error signal may be generated, for example, by a publicly known signal generating technique such as an astigmatic technique. A tracking error signal may be generated, for example, by a publicly known signal generating technique such as a push-pull technique.

The controller 12 receives servo signals from the signal processing circuit 11. Then, the controller 12 supplies a tracking control signal and a focusing control signal to the objective lens driving circuit 13 in order to realize tracking control and focusing control of the objective lens 5. The controller 12 also supplies a spherical aberration correction control signal to the spherical aberration correcting element driving circuit 14 in order to realize spherical aberration correction control by the expander lens 4. A spherical aberration correction control signal to be generated is such that it indicates a spherical aberration correction value optimum for a recording layer on which a focus is to be placed. More specifically, a spherical aberration correction value optimum for each recording layer is stored as a data table. A spherical aberration correction value corresponding to a recording layer on which a focus is to be placed is extracted from the data table, and then a spherical aberration correction control signal indicative of the extracted spherical aberration correction value is generated. Generally, a tracking control signal is generated such that it makes the level of a tracking error signal zero, and a focusing control signal is generated such that it makes the level of a focus error signal zero.

The objective lens driving circuit 13 drives the tracking part of the actuator 5a in response to a tracking control signal to cause the objective lens 5 to move in the direction of the disk radius that is perpendicular to the optical axis. The objective lens driving circuit 13 also drives the focusing part of the actuator 5a in response to a focusing control signal to cause the objective lens 5 to move in the direction of the optical axis. The spherical aberration correcting element driving circuit 14 drives the actuator 4c in response to a spherical aberration correction control signal to cause the second correction lens 4b to move in the direction of the optical axis.

In order to change a playback layer of the recording layers of the optical disk 10, an instruction for a focus jump is given to the controller 12 of the optical pickup device of the aforementioned structure. The instruction for a focus jump is issued, for example, by an optical disk playback device in which the present optical pickup device is provided. The instruction for a focus jump shows a target recording layer as a destination of a jump. As shown in FIG. 6, a recording layer nearest one surface of the disk 10 is a first recording layer, and a recording layer nearest the other surface that is opposite the one surface is an n^{th} recording layer. Further, a currently readable recording layer, namely a recording layer on which a laser beam spot is currently formed is a k^{th} recording layer, and a target recording layer is an m^{th} recording layer. The following relationships 1≦k≦n, and 1≦m≦n are established. The one surface of the disk 10 is a surface to be irradiated with a laser beam.

The controller 12 starts a focus jump operation in response to the received instruction for a focus jump. In the focus jump operation, it is determined whether the m^{th} target recording layer is nearer the first recording layer or nearer the n^{th} recording layer (step S1).

If the m^{th} target recording layer is nearer the n^{th} recording layer that is farthest from the one surface, namely, if |n−m|<m−1, it is determined whether the number of recording layers from the m^{th} recording layer to the n^{th} recording layer is smaller than that of recording layers from the current k^{th} recording layer to the mth target recording layer (step S2). This determination is intended to see whether the following first way of a focus jump requires a shorter time than the following second way of a focus jump in order for a focus to jump from the current k^{th} recording layer to the m^{th} recording layer near the n^{th} bottom recording layer. In the first way, a focus once jumps to the n^{th} bottom recording layer, and then jumps to the m^{th} target recording layer by passing through recording layers one by one. In the second way, a focus jumps directly to the m^{th} recording layer by passing through recording layers one by one. If |n−m|<|n−k| is true, the number of recording layers from the m^{th} target recording layer to the n^{th} bottom recording layer is smaller. Accordingly, a focus can jump in a short time. In this case, a spherical aberration correction control signal indicative of a spherical aberration correction value responsive to the n^{th} recording layer is generated (step S3). Then, a focusing control signal responsive to the n^{th} recording layer is generated for a focus to jump to the n^{th} recording layer (step S4). The process in step S8 follows the process in step S4.

As shown in FIG. 8, generation of a focusing control signal for a focus jump in step S4 is such that the focusing control signal moves the focus of a laser beam to a position slightly shifted toward the other surface from the n^{th} recording layer (step S41). Next, a focusing control signal is generated such that the focus position slightly shifted toward the other surface from the n^{th} recording layer gradually changes to get nearer the n^{th} recording layer (step S42). Then, it is determined whether the level (amplitude) of a focus error signal is detected (step S43). Reflected light of the laser beam is obtained as the laser beam gets nearer the n^{th} recording layer, thereby generating the level of the focus error signal. If the level is not generated, the flow returns to step S42. If generation of the level of the focus error signal is detected, a focusing control signal responsive to the focus error signal is generated such that the focus error signal converges to a zero-crossing point (step S44). Next, it is determined whether a zero-crossing point of the focus error signal is detected (step S45). Detection of the zero-crossing point of the focus error signal means that a focus has jumped to the n^{th} recording layer.

As shown in FIG. 9(a), the process in step S41 generates a focus jump J1 by which the focus of a laser beam is moved to a position slightly shifted toward the other surface from the n^{th} recording layer. The next process in step S42 moves the focus position as shown by numeral J2. The level of the focus error signal is generated as shown in FIG. 9(b) if the focus position gets nearer the n^{th} recording layer. If the level of the focus error signal is detected as a result of determination made in step S43, the focus error signal is directed to a zero-crossing point by the process in step S44. Detection of an initial zero-crossing point of the focus error signal means that a focus is placed on the n^{th} recording layer. The n^{th} recording layer currently becomes the k^{th} recording layer at the time of completion of the process in step S45.

If it is determined in step S2 that |n−m|≧|m−k|, a focus jumps to the m^{th} target recording layer in a shorter time if the focus passes through recording layers one by one. Accordingly, in this case, the flow bypasses steps S3 and S4, and proceeds to the process in step S8.

If it is determined in step S1 that the m^{th} target recording layer is nearer the first recording layer, namely, if |n−m|>m−1, it is determined whether the number of recording layers from the m^{th} recording layer to the first recording layer is smaller than that of recording layers from the current k^{th} recording layer to the m^{th} recording layer (step S5). This determination is intended to see whether the following first way of a focus jump requires a shorter time than the following second way of a focus jump in order for a focus to jump from the current k^{th} recording layer to the m^{th} recording layer nearer the first recording layer. In the first way, a focus once jumps to the first recording layer nearest the one surface, and then jumps to the m^{th} recording layer by passing through recording layers one by one. In the second way, a focus jumps directly to the m^{th} recording layer by passing through recording layers one by one. If m−1|<|m−k|, the number of recording layers from the m^{th} target recording layer to the first recording layer is smaller. Accordingly, a focus can jump in a short time. In this case, a spherical aberration correction control signal indicative of a spherical aberration correction value responsive to the first recording layer is generated (step S6). Then, a focusing control signal responsive to the first recording layer is generated for a focus to jump to the first recording layer (step S7). The process in step S8 follows the process in step S7.

As shown in FIG. 10, generation of a focusing control signal for a focus jump in step S7 is such that the focusing control signal moves the focus of a laser beam to a position slightly shifted toward the one surface from the first recording layer (step S71). Next, a focusing control signal is generated such that the focus position slightly shifted toward the one surface from the first recording layer gradually changes to get nearer the first recording layer (step S72). Then, it is determined whether the level (amplitude) of a focus error signal is detected (step S73). Reflected light of the laser beam is obtained as the laser beam gets nearer the first recording layer, thereby generating the level of the focus error signal. If the level is not generated, the flow returns to step S72. If generation of the level of the focus error signal is detected, a focusing control signal responsive to the focus error signal is generated such that the focus error signal converges to a zero-crossing point (step S74). Next, it is determined whether a zero-crossing point of the focus error signal is detected (step S75). Detection of the zero-crossing point of the focus error signal means that a focus has jumped to the first recording layer. The operations in steps S71 to S75 are the same as those in steps S41 to S45 respectively for placing a focus on the n^{th} recording layer. The first recording layer currently becomes the kth recording layer at the time of completion of the process in step S75.

If it is determined in step S5 that m−1≧|m−k|, a focus jumps to the m^{th} target recording layer in a shorter time if the focus passes through recording layers one by one. Accordingly, in this case, the flow bypasses steps S6 and S7, and proceeds to the process in step S8.

In step S8, a spherical aberration correction control signal indicative of a spherical aberration correction value is generated, the spherical aberration correction control signal which is responsive to a recording layer adjacent to the current k^{th} recording layer and nearer the m^{th} target recording layer than the current k^{th} recording layer. If the current k^{th} recording layer is nearer the one surface than the m^{th} recording layer, the adjacent recording layer is a (k+1)^{th} recording layer. If the current k^{th} recording layer is nearer the other surface than the m^{th} recording layer, the adjacent recording layer is the (k−1)^{th} recording layer. After the process in step S8, a focusing control signal responsive to the adjacent recording layer is generated for a focus to jump to the adjacent recording layer (step S9). Generation of the focusing control signal for a focus jump in step S9 is such that a focus position is on the adjacent recording layer. If a zero-crossing point of a focus error signal is detected, a focusing control signal responsive to the focus error signal is generated such that the focus error signal converges to the detected zero-crossing point.

After the process in step S9, it is determined whether a focus position has reached the m^{th} target recording layer (step S10). More specifically, the current k^{th} recording layer goes nearer the m^{th} target recording layer after each completion of the processes in steps S8 and S9. Accordingly, when k becomes equal to m, it is determined that a focus position has reached the m^{th} target recording layer. If k is not equal to m, a focus position does not reach the m^{th} target recording layer. In this case, the processes in steps S8 and S9 are repeated.

It is assumed, for example, that, in an optical disk with 16 recording layers in which a fifth recording layer is being played back, an instruction for a focus to jump to a thirteenth recording layer is supplied to the controller 12. In this case, the controller 12 executes the aforementioned focus jump operation in response to the instruction for a focus jump, thereby causing a focus position to move in a manner as indicated by arrows in FIG. 11. More specifically, a focus first jumps to a sixteenth recording layer. Next, the focus jumps to fifteenth, fourteenth, and thirteenth recording layers in this order, so that the focus is placed on the thirteenth recording layer. FIG. 11 does not show the movement of the focus to a position slightly shifted toward the other surface from the sixteenth recording layer that is made after the jump from the fifth recording layer.

It is also assumed that, in an optical disk with 16 recording layers in which a fifth recording layer is being played back, an instruction for a focus to jump to an eighth recording layer is supplied to the controller 12. In this case, a focus jumps to sixth, seventh, and eighth recording layers in this order, so that the focus is placed on the eighth recording layer, as indicated by arrows in FIG. 12.

As described above, if the number of recording layers from a target recording layer to one of a plurality of recording layers that is at either end is smaller than that of recording layers from a current recording layer to the target recording layer, the following first and second stages are performed. In the first stage, a focus jumps from the current recording layer to the recording layer at one end. The second stage is performed after the first stage. In the second stage, a focus repeats a jump by passing through recording layers one by one to get nearer a recording layer at the opposite end until the focus reaches the target recording layer. In a focus jump between recording layers, the number of times a focus performs a jump determines a time required to complete the focus jump. Accordingly, a focus can jump to the target recording layer in a short time if the number of focus jumps made in the second stage is smaller than that of focus jumps made in the case where the focus jumps from the current recording layer directly toward the target recording layer by passing through recording layers one by one. This means that a time required for a focus jump is shortened further as the number of recording layers from the current recording layer to the target recording layer becomes more and more large, compared to that of recording layers from the target recording layer to one of a plurality of recording layers that is at either end. Accordingly, a focus jump is effectively made by following the aforementioned first and second stages.

A spherical aberration correction control signal indicative of a spherical aberration correction value responsive to a recording layer at one end is generated before a focus jumps from the current recording layer to a recording layer at one end in the first stage. Thus, a focus error signal of a sufficient amplitude is obtained from the signal processing circuit 11 when a focus is at a position around the recording layer at the one end, so that the focus is reliably directed to the recording layer at the one end in the first stage.

In order for a focus to jump from the current recording layer to a target recording layer in the first stage that is a recording layer at the one end nearest the one surface of a disk, the focus may sequentially jump to reach the target recording layer after jumping once to the one surface of the disk. In the case of a disk with a very large number of layers, light of a laser beam should reach the bottom recording layer, and each recording layer is generally designed to have very low reflectance accordingly. Thus, the reflectance of a disk surface may be greater in some cases than that of recording layers even if the disk surface is covered with an antireflection coating. In this case, a focus jumps to the one surface of the disk more reliably than to the first recording layer near the one surface. Further, although depending on a disk structure, a focus jumps to the one surface of the disk more reliably if a distance between the one surface and the first recording layer is greater than that between recording layers. This makes a subsequent focus jump to the first recording layer reliable, thereby preventing a malfunction. A spherical aberration correction control signal indicative of a spherical aberration correction value responsive to the position of the disk surface is generated immediately before a focus jumps to the disk surface.

In a multilayer recording disk, in order for a focus to jump from a current recording layer to a recording layer at one end near a disk surface in the first stage, a focus may sequentially jump to reach a target recording layer after jumping once to a servo guide track layer. In the case of a recording disk with a very large number of layers, a guide track is not provided for each recording layer, but a guide track layer is provided separately from recording layers in light of cost and easiness of manufacturing disks. Then, while a guide track is traced with a laser beam as guide light, recording and playback to and from a recording layer are realized with a laser beam as recording and playback light as shown in FIGS. 13 to 15. The guide track layer may be placed at a position between a bottom recording layer and the other surface of the disk, a position between the one surface of the disk and a first recording layer, or a position midway in a group of recording layers. If the guide track layer is provided, a distance between the guide track layer and a recording layer nearest the guide track layer is generally made greater than that between recording layers. This prevents part of recording and playback light to enter a playback signal after being reflected off the guide track layer. Thus, it is quite likely that a focus jumps to the guide track layer more reliably than to a recording layer. This also prevents a malfunction during a focus jump. A spherical aberration correction control signal indicative of a spherical aberration correction value responsive to the position of the guide track layer is generated immediately before a focus jumps to the guide track layer.

In Example described above, a spherical aberration correction control signal indicative of a spherical aberration correction value responsive to the n^{th} recording layer is generated in step S3. The spherical aberration correction control signal may alternatively be indicative of a spherical aberration correction value responsive to a position slightly shifted toward the other surface from the n^{th} recording layer. Likewise, a spherical aberration correction control signal indicative of a spherical aberration correction value responsive to the first recording layer is generated in step S6. The spherical aberration correction control signal may alternatively be indicative of a spherical aberration correction value responsive to a position slightly shifted toward the one surface from the first recording layer. It is most desirable that only a focus error signal relating to a recording layer as a destination of a focus jump be obtained in the destination recording layer, and that a focus error signal relating to an adjacent recording layer be not present in the destination recording layer. However, an actual situation is that the amplitude of a focus error signal gradually decreases with a peak placed at a recording layer for which spherical aberration correction is optimized. Accordingly, if spherical aberration correction is optimized for a recording layer as a destination of a focus jump, a sufficient amplitude of a resultant focus error signal is obtained in recording layers adjacent to the destination recording layer. There is no recording layer deeper than the n^{th} recording layer at the bottom of a disk. Taking advantage of this feature, in order for a focus to jump to the n^{th} bottom recording layer, a spherical aberration correction value is adjusted to a deeper position. In this case, the amplitude of a focus error signal is reduced to a satisfactorily low level in an (n−1)^{th} recording layer that is a second layer from the bottom, thereby making a focus jump to the n^{th} bottom recording layer more reliable. This also applies to the case of a focus jump to the first recording layer nearest the one surface.

In Example described above, the optical recording medium is an optical disk with a plurality of stacked recording layers. However, the shape of the optical recording medium is not necessarily a disk. The optical recording medium may also be an optical memory with a plurality of stacked recording layers.

In Example described above, in the second stage performed after the first stage, a focus makes a jump from a recording layer at one end to a target recording layer by passing through recording layers one by one. Alternatively, a focus may jump to the target recording layer not by passing through recording layers one by one, but by passing through two or more layers at a time.

Further, the spherical aberration correcting means is not limited to the expander lens as shown in Example described above, but it may be a liquid crystal element.

The invention is effectively applied for an optical recording medium with five or more stacked recording layers. The invention more effectively shortens a time required for a focus jump as the number of recording layers from a current in-focus recording layer to a target recording layer becomes more and more large, compared to that of recording layers from the target recording layer to a recording layer at one end.

### BRIEF DESCRIPTION OF DRAWINGS

FIG. 1 is a diagram showing a playback state where the focus of a laser beam is placed on a fifth recording layer of a multilayer optical disk, and the amplitude of waveform of a focus error signal.

FIG. 2 is a diagram showing the amplitude of waveform of a focus error signal.

FIG. 3 is a diagram showing an exemplary amplitude of waveform of a focus error signal at a position around a thirteenth recording layer generated when a focus jumps from a fifth recording layer to the thirteenth recording layer.

FIG. 4 is a diagram showing a destination to which a focus is directed and an exemplary amplitude of waveform of a focus error signal when a focus jumps from a fifth recording layer to a thirteenth recording layer after spherical aberration is suitably corrected.

FIG. 5 is a diagram showing the structure of an optical pickup device to which the invention is applied.

FIG. 6 is a diagram showing a current in-focus recording layer and a target recording layer of a plurality of recording layers of a multilayer optical disk.

FIG. 7 is a flow chart for explaining a focus jump operation realized by a controller provided in the device shown in FIG. 5.

FIG. 8 is a flow chart for explaining in detail a focus jump operation to an n^{th} recording layer that is part of the focus jump operation explained in FIG. 7.

FIG. 9 is a diagram showing a focus jump operation to a sixteenth recording layer that is the n^{th} recording layer shown in FIG. 8, and the amplitude of waveform of a focus error signal.

FIG. 10 is a flow chart for explaining in detail a focus jump operation to a first recording layer that is part of the focus jump operation explained in FIG. 7.

FIG. 11 is a diagram showing a path of movement through which a focus jumps from a fifth recording layer to a thirteenth recording layer.

FIG. 12 is a diagram showing a path of movement through which a focus jumps from a fifth recording layer to an eighth recording layer.

FIG. 13 is a diagram showing the structure of a multilayer optical disk with a guide track layer.

FIG. 14 is a diagram showing the structure of a multilayer optical disk with a guide track layer.

FIG. 15 is a diagram showing the structure of a multilayer optical disk with a guide track layer.

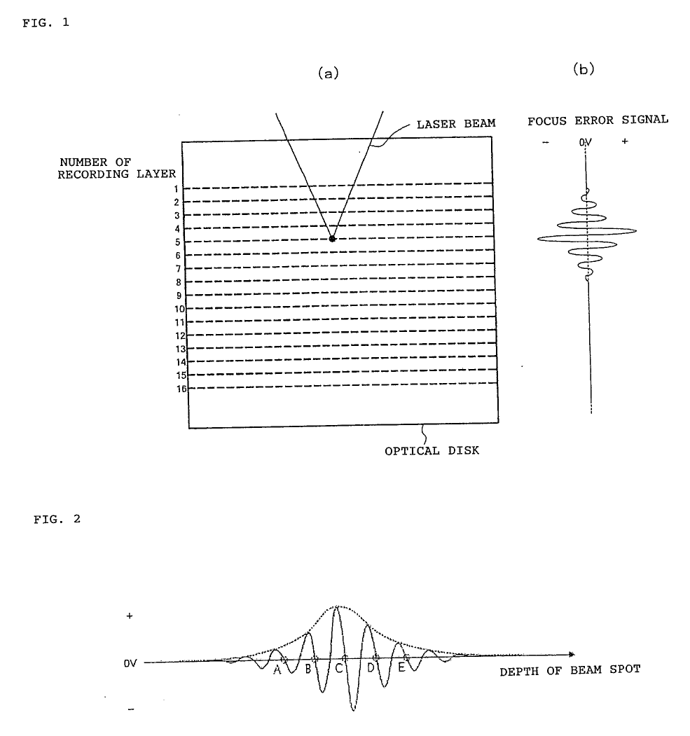

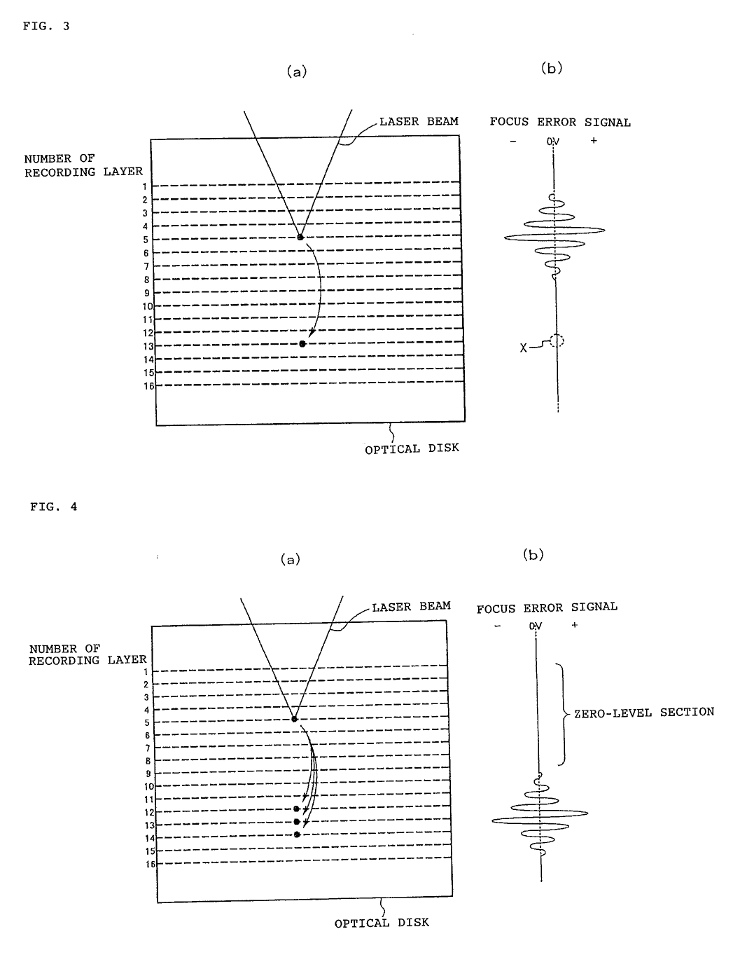

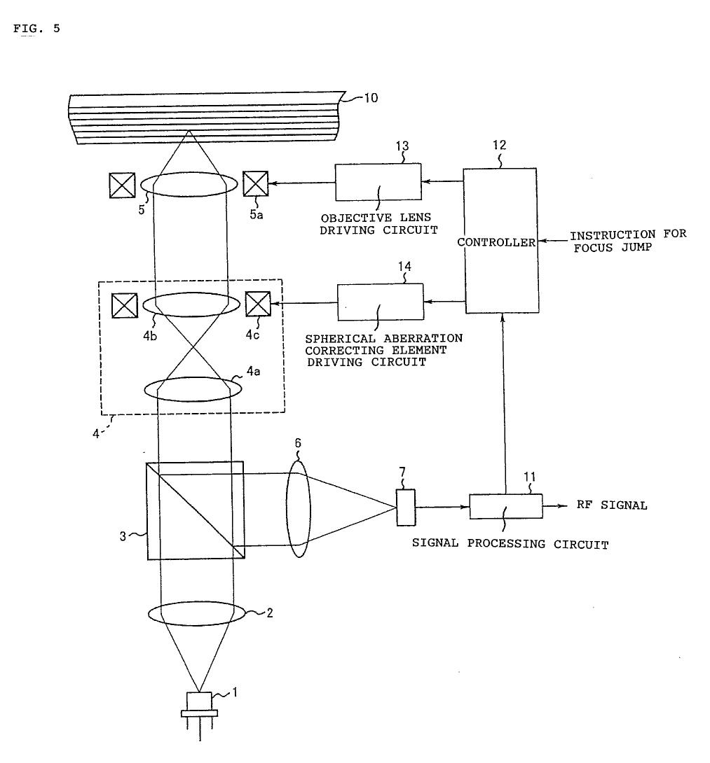

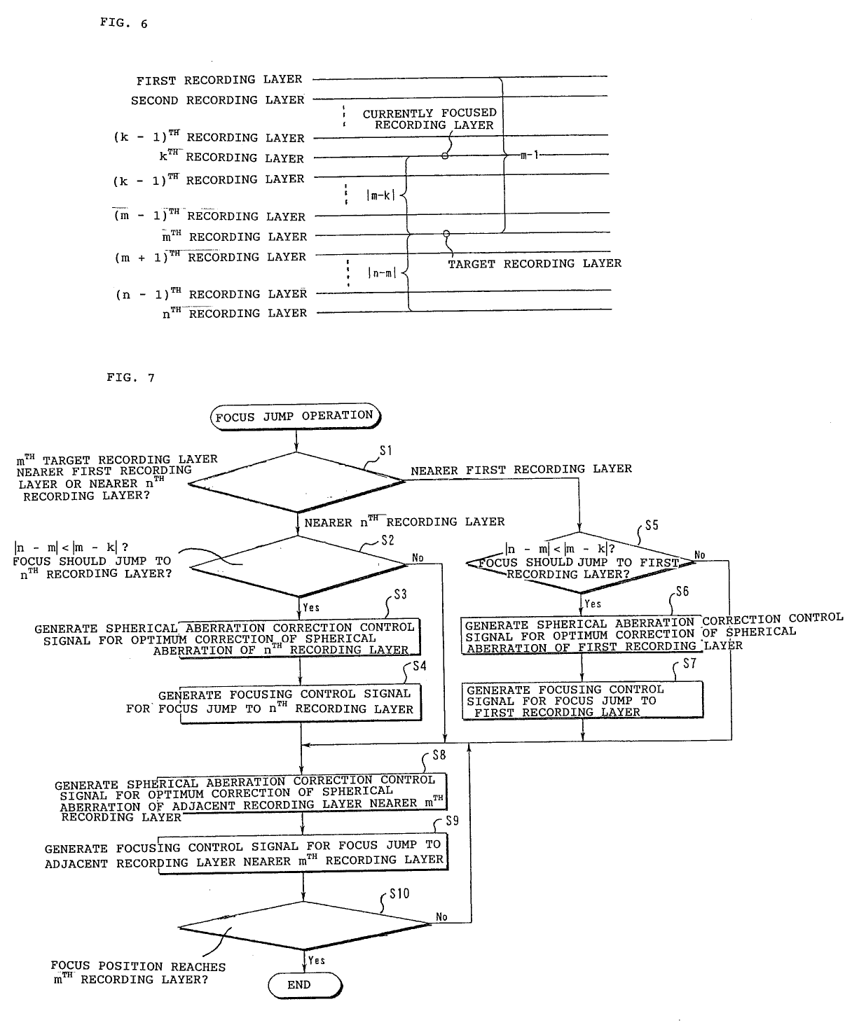

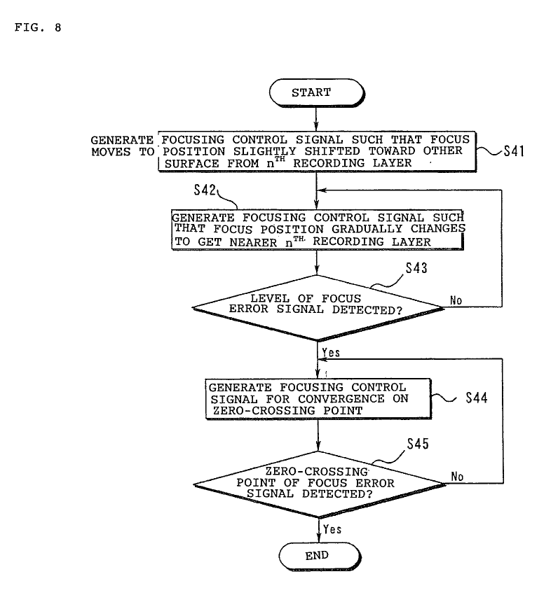

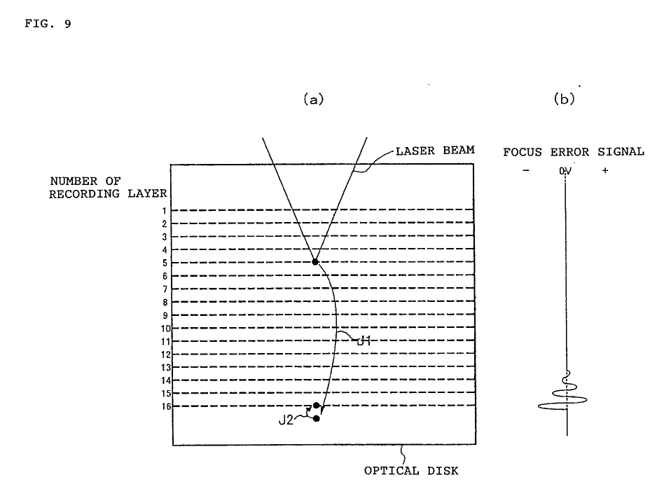

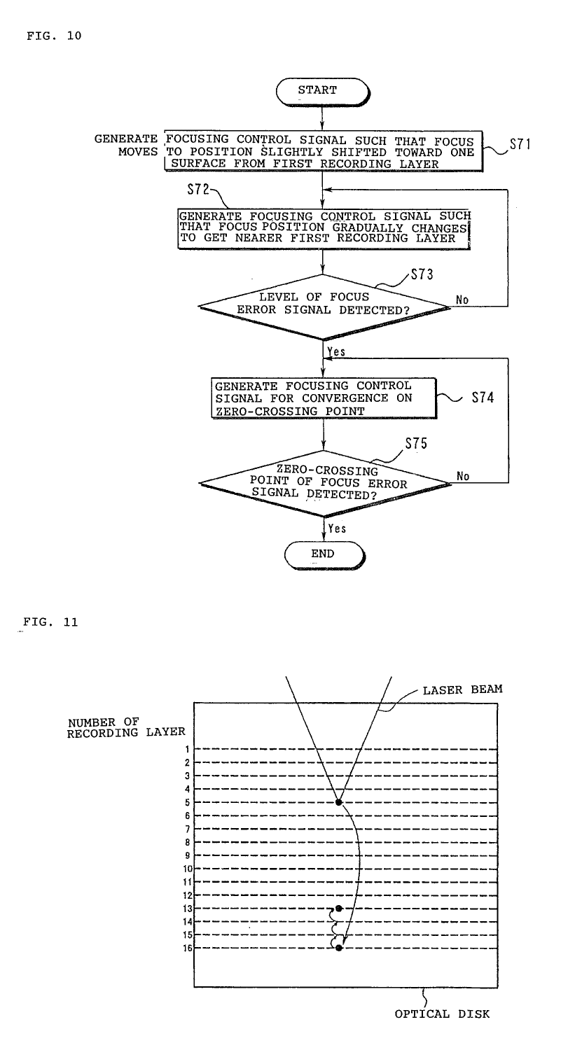

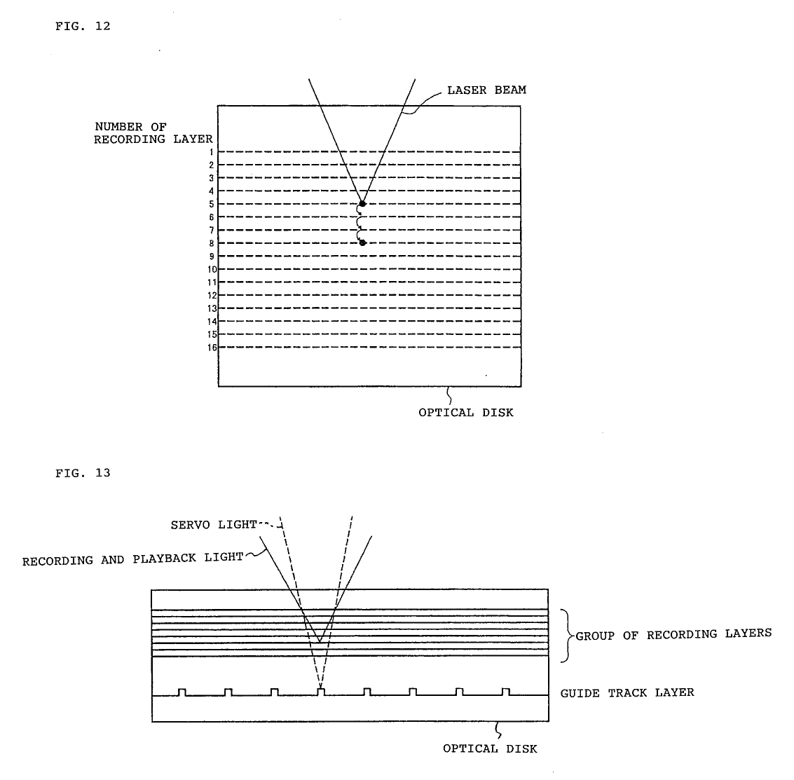

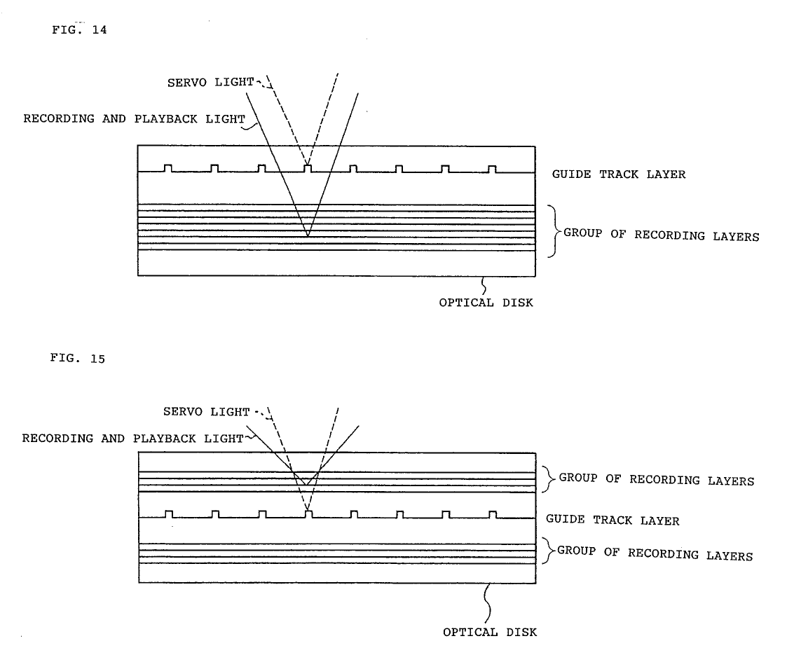

### EXPLANATION OF REFERENCE SIGNS

1 Light source
3 Beam splitter
4 Expander lens
5 Objective lens
7 Light receiving element
11 Signal processing circuit
12 Controller
13 Objective lens driving circuit
14 Spherical aberration correcting element driving circuit

1-7. (canceled)

8. An optical pickup device for optically reading or writing information from and to an optical recording medium with a plurality of stacked recording layers, comprising:
a light source for emitting a laser beam for reading or writing;
an optical system for directing the laser beam emitted from the light source through an objective lens to apply the laser beam to the optical recording medium;
a focus actuator for causing the objective lens to move in a direction of an optical axis of the objective lens such that a focus of the laser beam is placed within at least a range of the plurality of recording layers;
a spherical aberration correcting part in the optical system provided on an optical path between the light source and the objective lens, the spherical aberration correcting part making optimum correction of spherical aberration generated in the optical system including the optical recording medium; and
a control part for controlling each of the focus actuator and the spherical aberration correcting part, wherein
the control part includes: a first stage part, in response to generation of an instruction for a focus jump from a current in-focus recording layer to a target recording layer of the plurality of recording layers, in order to make optimum correction of spherical aberration responsive to a position of a recording layer at one end nearer the target recording layer than the current in-focus recording layer, the recording layer at the one end being one of recording layers at opposite ends of the plurality of recording layers, the first stage part controlling the spherical aberration correcting part, and then controlling the focus actuator, thereby causing the focus to jump to the recording layer at the one end; and
a second stage part, after the focus jumps to the recording layer at the one end by the first stage part, in order to make optimum correction of spherical aberration responsive to a position of a different recording layer shifted by at least one recording layer from the recording layer at the one end toward the target recording layer, the second stage part controlling the spherical aberration correcting part, then controlling the focus actuator, causing the focus to jump to the different recording layer, and repeating such a focus jump until the focus reaches the target recording layer.

9. The optical pickup device according to claim 8, wherein: the control part includes determining part for determining whether the number of recording layers from the target recording layer to the recording layer at the one end is smaller than that of recording layers from the current in-focus recording layer to the target recording layer;
the first and second stage part are executed if the number of recording layers from the target recording layer to the recording layer at the one end is smaller than that of recording layers from the current in-focus recording layer to the target recording layer; and
if the number of recording layers from the target recording layer to the recording layer at the one end is the same as or greater than that of recording layers from the current in-focus recording layer to the target recording layer, in order to make optimum correction of spherical aberration responsive to a position of a different recording layer shifted by at least one recording layer from the current in-focus recording layer toward the target recording layer, the spherical aberration correcting part is controlled, then the focus actuator is controlled to cause the focus to jump to the different recording layer, and such a focus jump is repeated until the focus reaches the target recording layer.

10. The optical pickup device according to claim 8, wherein the first stage part causes the focus to jump from the in-focus recording layer to a position near the recording layer at the one end and defined between the recording layer at the one end and one surface of the optical recording medium, and thereafter causes the focus to jump to the recording layer at the one end.

11. The optical pickup device according to claim 8, wherein the first stage part causes the focus to jump from the in-focus recording layer to one surface of the optical recording medium near the recording layer at the one end, and thereafter causes the focus to jump to the recording layer at the one end.

12. The optical pickup device according to claim 8, wherein: the optical recording medium has a guide track layer that is optically traced when information is written to each of the plurality of recording layers; and
the first stage part causes the focus to jump from the in-focus recording layer to the guide track layer, and thereafter causes the focus to jump to the recording layer at the one end.

13. The optical pickup device according to claim 8, wherein: the control part includes signal processing part for generating a focus error signal in response to an output of received light of the laser beam reflected off the optical recording medium, the focus error signal being indicative of a degree of shift of a focus position of the laser beam from the recording layer; and
the first stage part causes the focus to jump to each of the recording layer at the one end, to the different recording layer, and to the target recording layer in response to the focus error signal.

14. A method of a focus jump performed in an optical pickup device including: an optical system for directing a laser beam emitted from a light source through an objective lens to apply the laser beam to an optical recording medium with a plurality of stacked recording layers; a focus actuator for causing the objective lens to move in a direction of an optical axis of the objective lens such that the focus of the laser beam is placed within at least a range of the plurality of recording layers; and spherical aberration correcting part in the optical system provided on an optical path between the light source and the objective lens, the spherical aberration correcting part making optimum correction of spherical aberration generated in the optical system including the optical recording medium, the method of a focus jump causing a focus to jump from a current in-focus recording layer to a target recording layer of the plurality of recording layers, the method of a focus jump comprising:
a first stage, in order to make optimum correction of spherical aberration responsive to a position of a recording layer at one end nearer the target recording layer than the current in-focus recording layer, the recording layer at the one end being one of recording layers at opposite ends of the plurality of recording layers, the first step controlling the spherical aberration correcting part, and then controlling the focus actuator, thereby causing the focus to jump to the recording layer at the one end; and
a second stage performed after the first stage, in order to make optimum correction of spherical aberration responsive to a position of a different recording layer shifted by at least one recording layer from the recording layer at the one end toward the target recording layer, the second step controlling the spherical aberration correcting part, then controlling the focus actuator, causing the focus to jump to the different recording layer, and repeating such a focus jump until the focus reaches the target recording layer.

15. An optical pickup device for optically reading or writing information from and to an optical recording medium with a plurality of stacked recording layers, comprising:
a light source for emitting a laser beam for reading or writing;
an optical system for directing the laser beam emitted from the light source through an objective lens to apply the laser beam to the optical recording medium;
a focus actuator for causing the objective lens to move in a direction of an optical axis of the objective lens such that a focus of the laser beam is placed within at least a range of the plurality of recording layers;
spherical aberration correcting means in the optical system provided on an optical path between the light source and the objective lens, the spherical aberration correcting means making optimum correction of spherical aberration generated in the optical system including the optical recording medium; and
control means for controlling each of the focus actuator and the spherical aberration correcting means, wherein
the control means includes: first stage means, in response to generation of an instruction for a focus jump from a current in-focus recording layer to a target recording layer of the plurality of recording layers, in order to make optimum correction of spherical aberration responsive to a position of a recording layer at one end nearer the target recording layer than the current in-focus recording layer, the recording layer at the one end being one of recording layers at opposite ends of the plurality of recording layers, the first stage means controlling the spherical aberration correcting means, and then controlling the focus actuator, thereby causing the focus to jump to the recording layer at the one end; and
second stage means, after the focus jumps to the recording layer at the one end by the first stage means, in order to make optimum correction of spherical aberration responsive to a position of a different recording layer shifted by at least one recording layer from the recording layer at the one end toward the target recording layer, the second stage means controlling the spherical aberration correcting means, then controlling the focus actuator, causing the focus to jump to the different recording layer, and repeating such a focus jump until the focus reaches the target recording layer.

16. The optical pickup device according to claim 15, wherein: the control means includes determining means for determining whether the number of recording layers from the target recording layer to the recording layer at the one end is smaller than that of recording layers from the current in-focus recording layer to the target recording layer;
the first and second stage means are executed if the number of recording layers from the target recording layer to the recording layer at the one end is smaller than that of recording layers from the current in-focus recording layer to the target recording layer; and
if the number of recording layers from the target recording layer to the recording layer at the one end is the same as or greater than that of recording layers from the current in-focus recording layer to the target recording layer, in order to make optimum correction of spherical aberration responsive to a position of a different recording layer shifted by at least one recording layer from the current in-focus recording layer toward the target recording layer, the spherical aberration correcting means is controlled, then the focus actuator is controlled to cause the focus to jump to the different recording layer, and such a focus jump is repeated until the focus reaches the target recording layer.

17. The optical pickup device according to claim 15, wherein the first stage means causes the focus to jump from the in-focus recording layer to a position near the recording layer at the one end and defined between the recording layer at the one end and one surface of the optical recording medium, and thereafter causes the focus to jump to the recording layer at the one end.

18. The optical pickup device according to claim 15, wherein the first stage means causes the focus to jump from the in-focus recording layer to one surface of the optical recording medium near the recording layer at the one end, and thereafter causes the focus to jump to the recording layer at the one end.

19. The optical pickup device according to claim 15, wherein: the optical recording medium has a guide track layer that is optically traced when information is written to each of the plurality of recording layers; and
the first stage means causes the focus to jump from the in-focus recording layer to the guide track layer, and thereafter causes the focus to jump to the recording layer at the one end.

20. The optical pickup device according to claim 15, wherein: the control means includes signal processing means for generating a focus error signal in response to an output of received light of the laser beam reflected off the optical recording medium, the focus error signal being indicative of a degree of shift of a focus position of the laser beam from the recording layer; and
the first stage means causes the focus to jump to each of the recording layer at the one end, to the different recording layer, and to the target recording layer in response to the focus error signal.
